(19) United States
(12) Patent Application Publication
(10) Pub. No.: US 2016/0004819 A1
(43) Pub. Date: Jan. 7, 2016

(54) APPARATUS FOR STAGING OF PATIENTS FROM MEDICAL IMAGE DATA

(71) Applicant: Siemens Medical Solutions USA, Inc., Malvern, PA (US)

(72) Inventor: Matthew David Kelly, Botley (GB)

(73) Assignee: SIEMENS MEDICAL SOLUTIONS USA, INC., Malvern, PA (US)

(21) Appl. No.: 14/790,183

(22) Filed: Jul. 2, 2015

(30) Foreign Application Priority Data
Jul. 4, 2014 (GB) 1411966.3

(51) Int. Cl. G06F 19/00

(52) U.S. Cl. CPC G06F 19/321; G06F 19/322; G06F 19/345

(57) ABSTRACT

The present invention concerns a system for calculating a suggested patient stage, the system including a processor and an associated display monitor, at which patient medical image data are displayed together with a form. The form has entry locations therein at which data can be entered by a user of the processor, and automatically from a data source that is accessible by the processor. The processor applies the data entered into the form in order to stage guidelines embodied in a logic algorithm that is used by the processor to calculate a suggested stage for the patient. The calculated suggested stage is displayed at the display monitor.

### BACKGROUND OF THE INVENTION

1. Field of the Invention

The present invention relates to methods and equipment for “staging” patients: that is, monitoring progress of the patient in regards to the development of a disease or other malady.

The present invention will be described with reference to staging of cancer patients, but may be applied to the staging of any patient development which may be assessed with reference to image data.

2. Description of the Prior Art

Conventionally, medical images are captured of a cancer patient at intervals to monitor the progress of a tumor. A clinician will typically review those medical images, along with earlier images of the same patient. This will give some indication of the progress of the patient and the development of the tumor.

Accurate assessment of the stage of a cancer is necessary for treatment selection and determining the prognosis of the patient. However, in order to provide a complete staging, many different factors need to be taken into consideration, and this may be difficult for a clinician to retain and evaluate all of these factors in mind when viewing the images.

The factors to take into consideration when staging a patient are different for each different type of cancer. For example, the 7^{th} edition of the AJCC (American Joint Committee on Cancer) Cancer Staging Manual (2010) provides guidelines on staging for 54 different cancer types or sites. Each guideline describes how combinations of clinical features map together to stage a cancer tumor. Many of these clinical features are, or may be, derived from medical image data.

Given the range of cancer types, each typically having different staging guidelines, and the number of potential lesions in some patients, it can be an intellectually- and labor-intensive task to accurately stage and report a case. This task is complicated further for clinicians less familiar with a particular cancer type and its respective staging guideline.

Clearly, to take all of these guidelines into account when staging a patient requires some sort of reference tool to aid a clinician when staging a patient.

Typically, the reference tool is a staging handbook. This is less than optimal for a clinician, who has to locate the required entry in the book, read and interpret the relevant guideline and apply it to the case in hand. This presents numerous opportunities for errors and omissions.

The present invention aims to automate application of such guidelines, at least to some extent, to reduce the opportunities for errors and omissions when staging a patient.

The software tool known as StageCRAFT version 3.94 is available from www.tumourstager.com and provides a checkbox form to help clinicians through the process of staging oncology imaging studies for a selection of cancer types. StageCRAFT has no integration with a clinical reading application, which means that a user will have to manually populate the fields in the form, and then manually transfer a computed stage into a chosen reporting environment.

### SUMMARY OF THE INVENTION

The present invention concerns a system for calculating a suggested patient stage, the system including a processor and an associated display monitor, at which patient medical image data are displayed together with a form. The form has entry locations therein at which data can be entered by a user of the processor, and automatically from a data source that is accessible by the processor. The processor applies the data entered into the form in order to stage guidelines embodied in a logic algorithm that is used by the processor to calculate a suggested stage for the patient. The calculated suggested stage is displayed at the display monitor.

### BRIEF DESCRIPTION OF THE DRAWINGS

FIG. 1 represents a screen display illustrating potential lesions based on their ability to influence the stage of a cancer patient, as presented in an embodiment of the invention.

FIG. 2 represents a screen display of a system according to an embodiment of the present invention when operational and performing a method according to the present invention.

FIG. 3 schematically represents a system according to an embodiment of the present invention.

### DESCRIPTION OF THE PREFERRED EMBODIMENTS

The present invention provides a semi-automated system and methods for assisting a clinician in staging a patient, where data available from patient medical image data is made available to a staging sub-system, along with data entered manually by a clinician, and data retrieved from a patient record.

In a preferred embodiment, the present invention provides a support system for patient staging which is integrated into a clinical medical image reading application.

A user may be presented with a representation of potential lesions. These potential lesions may be malignant or benign. Further investigation is required to determine their status. Such potential lesions may require pathological confirmation; however, if the confirmation as malignant or benign would not in fact affect the patient stage, the cost or risk of performing additional procedures may not be justified and should be avoided where possible. A user reading patient data should identify the potential lesions whose classification may change the stage, and therefore treatment plan, for a patient. These potential lesions will be referred to as “stage-critical” lesions. Pathological confirmation may be preferentially directed to those stage-critical lesions.

The present invention assists the user with production of a report detailing lesion sites influencing the clinical stage of the patient. This is of help to the user in cases with multiple lesions such as typically found in lymphoma investigations.

The present invention also assists a user in efficiently and accurately reading cases of a type less familiar to the user. Conventionally, additional resources such as staging handbooks would need to be consulted but the present invention provides evaluation of potential lesions without need to resort to such additional resources.

In certain embodiments of the present invention, a relationship between potential lesion and cancer stage can be determined by first encoding the staging guidelines in a machine-interpretable format such as XML. Potential lesions within patient image data may be identified based on ¹⁸F-FDG uptake. Given any clinician-confirmed lesions, the ability of each of the remaining potential lesions to modify the tumor stage, based on anatomical location and type, is evaluated with the resultant stage associated with the potential lesion. Any stage-critical lesions found will be identified as such.

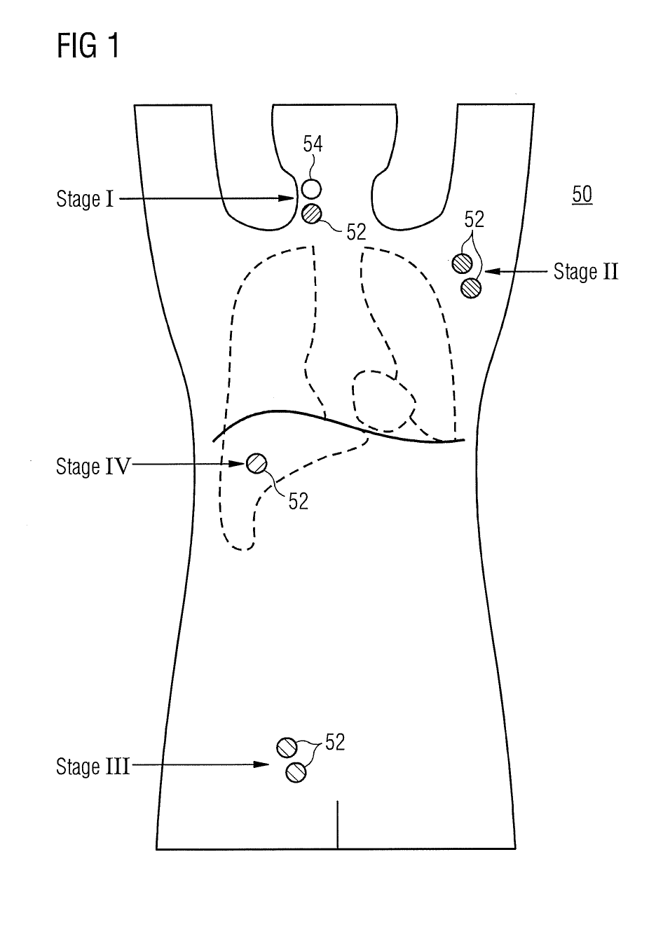

FIG. 1 represents a screen display illustrating potential lesions based on their ability to influence the stage of a cancer patient, as presented in an embodiment of the invention. The potential lesions 52 identified from patient image data are shown on a body map 50, along with a representation of any lesions 54 confirmed by a user.

For each possible tumor stage, the potential lesions 52 are grouped according to whether they are “stage-critical” lesions. The shown potential lesions 52 are coded according to whether they are stage-critical or not, and which stage is involved. For example, the potential lesions may be represented as colored contour overlay. In an example, only the stage-critical lesions are shown, and the upper stage which may depend on a stage-critical lesion is represented by the color of the contour overlay representing that stage-critical lesion. Such an example is shown in

FIG. 1, where different shading patterns represents the color coding of the contour maps. Of course, differing shading patterns may be used instead of, or in addition to, differing colors.

In other arrangements, all potential lesions are shown on the body map, colored and/or shaded according to the stage represented by the particular potential lesion. Stage-critical lesions may be indicated as a combination of two representations—partially colored or shaded with the respective identifiers for the two possible stages indicated by the stage-critical lesion, or animated such as flickering between identifiers of the two possible stages.

Each identified stage-critical lesion should be investigated by a user to confirm the stage represented. As the status of each potential lesion is confirmed, the display may be updated. Some stage-critical lesions may become non-stage-critical following confirmation of status of other potential lesions. Data represented in the map 50 is then preferably updated with information from the user's evaluation, until a stage can be identified with some confidence for the patient.

Such display arrangements may assist the user in their staging task in at least the following ways.

By highlighting the stage-critical lesions, which may change the identified cancer stage and therefore the subsequent treatment, the user may efficiently direct pathological confirmation by biopsy to stage-critical lesions which will determine the patient stage without wasting resources in biopsy, or other diagnostic procedures such as additional medical imaging procedures, on lesions which will not affect the patient stage.

By grouping lesions by their influence on patient stage, the user can direct pathological effort and ensure that all relevant groups are confirmed and reported.

By employing the present invention, users who are relatively inexperienced in staging a particular cancer type are able to easily identify the regions, such as stage-critical lesions, which are of importance to the staging of the particular patient.

Alternative methods may be used to present the grouping of the lesions and potential lesions to the user. For example, a user-toggled on/off colored mask may be provided for each system-identified potential lesion.

The potential lesions may be indicated on an MIP (Maximum Intensity Projection) or MPR (Multi-Planar Reconstruction) image.

Potential lesions that haven't been explicitly excluded that may change the patient stage could be flagged to the user prior to completion of the image read.

The invention may also be extended to consider non-lesion pathologies able to influence staging, for example atelectasis.

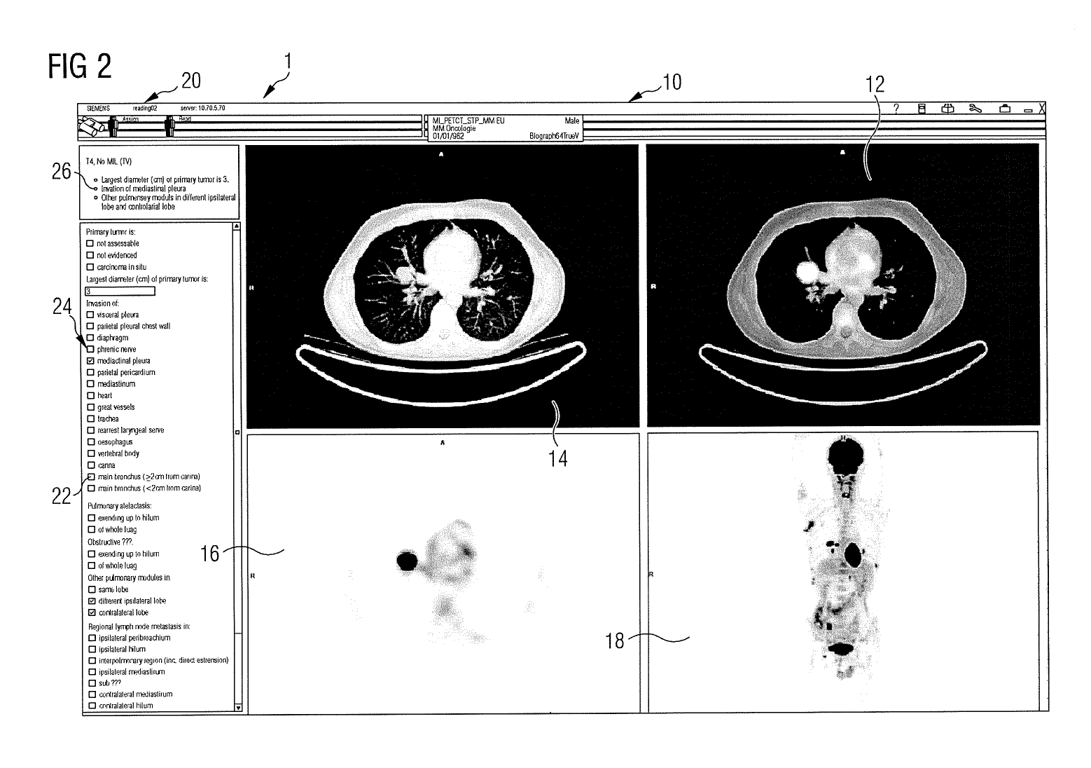

FIG. 2 represents a screen display of a system according to an embodiment of the present invention when operational and performing a method according to the present invention.

As illustrated, a screen display 1 has an image part 10, where one or more medical images may be displayed in a clinical reading application, and a form section 20, where data and selections relevant to the patient and the staging task in question are displayed, and where a user may manually enter data and make selections. In preferred embodiments, the present invention provides integration of support for patient staging directly into the clinical reading application.

In FIG. 2, four images are on display. This may be a typical scenario for a staging process, but the present invention does not require such multi-image displays. As shown, three transverse images 12, 14, 16 are shown, along with a whole body coronal maximum intensity projection (MIP) image, useful for locating the planes of the other images 12, 14, 16 within the body of the patient. The whole body coronal MIP image may be the representation discussed above with reference to FIG. 1.

Typically, all images will relate to a single patient, and may, as in this example, show a same view in different modalities. Alternatively, similar views in a same modality but taken at different times may be displayed to evaluate progression of a tumor, for example. Alternatively, different views may be shown, captured at a same time in a same modality, for example to evaluate the extent of a feature such as a tumor in the dimension perpendicular to the images.

The form section 20 is shown at the left-hand side in this example. The form section may alternatively be displayed at other positions, or on a separate screen; or in a “pop-up” window, or in an alternate screen display which may be switched to by user selection.

The form section contains a number of labeled check-boxes 22 which may be arranged into groups 24 of check boxes. A region 26 may contain identifiers, listing information identifying the images, the patient, the present time, and so on. It may contain a textual summary of the data indicated by the data fields and the checkboxes.

Data entry fields may also be provided, and may be included in some of the groups 24, or in a separate group for such fields, or may be ungrouped.

A similar arrangement of check-boxes in groups is provided in the 7^{th} edition of the AJCC (American Joint Committee on Cancer) Cancer Staging Manual (2010), and so this layout and data capture technique will be familiar to those skilled in the art.

Although not visible in the drawing, a system is provided to apply the data captured in the check boxes and data entry field to combinations and evaluations which embody guidelines on staging, for example similar to those discussed above in relation to the AJCC Cancer Staging Manual. In an example embodiment, the system may be embodied in software such as XML to encode cancer-type-specific logic with JavaScript as a cancer-type-independent engine to execute the logic required to support a clinician in staging. Other coding languages may of course be used for equivalent effect.

In use, a clinician may segment features on the medical images. For example, a clinician may identify a tumor on one of the images, by any known segmentation method. The system may evaluate this segmentation to derive dimensions of the tumor, indications regarding its position and so on, and use these dimensions in the evaluations used for staging. Other information will be known to the system, such as the time that has elapsed since the capture of each image, the time that has elapsed since the previous staging, the locations of the image planes within the body of the patient, and so on. This information may also be provided to the evaluations. Organ segmentation may be carried out by any suitable manual or automated method, and the system may use such segmentation to derive information such as the location of a tumor within an organ; the relative size of an organ, and so on. Such information may also be provided to the evaluations.

A significant advantage to providing organ segmentation is that the form section 20 may be tailored to include only data capture fields and checkboxes which are relevant to the organ(s) being viewed. A cancer-type-specific staging form may be displayed, which includes only checkboxes and data entry fields relevant to the particular cancer type applicable to the viewed organ.

Data fields and checkboxes should preferably be automatically filled by the system from data about, or shown in, the images, with remaining data fields and checkboxes left to be manually completed by the clinician. Preferably, the automatically-filled data fields and check boxes may be manually overwritten by the clinician.

Once the data fields and the check boxes have been sufficiently completed, the system may carry out an automated evaluation and provide a calculation of the tumor stage. Preferably, options are provided to override this calculation, and to make changes to the data fields and the check boxes with a view to re-calculating the stage. In an example embodiment, the system employs a type of argumentation theory, although alternative technologies could be used.

The calculated stage may then be displayed to the clinician. A text summary of the staging information provided to the system may be displayed to the clinician, and may also be included in a clinical report, which may be automatically, or semi-automatically, generated by the system.

Once the staging calculation is complete, a machine-interpretable summary of the staging information and/or result may be stored with the corresponding imaging data for future use, such as for data mining. In specific examples, such information may be included using the DICOM-SR format (Hussein et al. DICOM structured reporting: Part 1. Overview and characteristics. Radiographics 2004;24:891-896), or the XML AIM format (Channin et al. The caBIG annotation and image markup project. J Digit Imaging 2010;23:217-225.). The summary of the staging information and/or result may be stored directly into a DICOM header of the corresponding image series.

Preferably, the check boxes and data entry fields are presented to a user in a context-sensitive manner. For example, when a user segments a lung lesion which is close to the mediastinum, which may be determined based on proximity of anatomical landmarks or organ segmentations, then fields relating to the invasion of the mediastinum or distance to the carina may be presented to the user, although they had been hidden until that proximity determination had been made. This simplifies the form section 20, since only those check boxes relevant to the presently-viewed organ are shown. This provides the advantage that specific sub-regions of the image volume may be associated with individual fields.

The logic used to compute a patient stage from the form input can also be used to support the evaluation of alternative hypotheses for stage-critical lesions. For example, for lesions classified as stage-critical by the user, the system can compute and present the alternative staging possibilities when those lesions are hypothetically classified as benign or malignant. This could inform patient management decisions such as whether or not to biopsy the suspicious lesion.

Data entry fields or check boxes which have not been completed, but could affect the computed stage may be highlighted to a user for completion.

The present invention may be applied to other image-based clinical assessments where explicit criteria are used to classify the status of a patient.

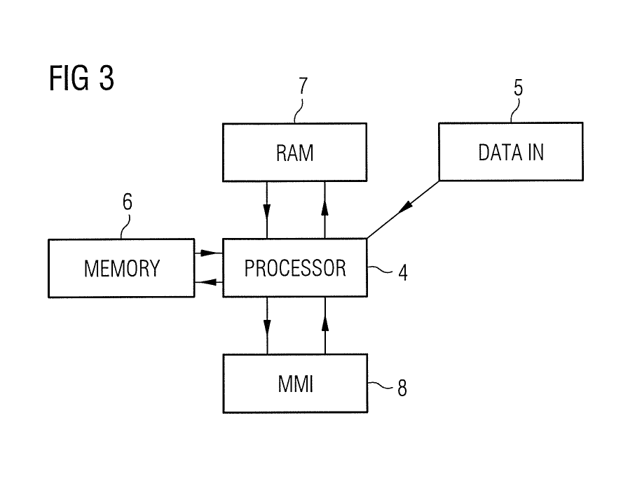

Referring to FIG. 3, the above embodiments of the invention may be conveniently realized as a computer system suitably programmed with instructions for carrying out the steps of the methods according to the invention.

For example, a central processing unit 4 is able to receive data representative of medical scans via a port 5 which could be a reader for portable data storage media (e.g. CD-ROM); a direct link with apparatus such as a medical scanner (not shown) or a connection to a network.

For example, in an embodiment, the processor performs such steps as displaying patient medical image data together with a form section for entry of data by a user and automatically by the system; applying the data entered into the form section to staging guidelines embodied in logic within the system, thereby to calculate a suggested stage for the patient.

Software applications loaded on memory 6 are executed to process the image data in random access memory 7.

A Man-Machine interface 8 typically includes a keyboard/mouse/screen combination (which allows user input such as initiation of applications) and a screen on which the results of executing the applications are displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A system for calculating a suggested patient stage, comprising:
a processor;
a display monitor in communication with said processor;
said processor having access to a data base containing patient medical image data and said processor being configured to display said patient medical image data at said display monitor together with a form having entry locations therein allowing entry of data into said form locations by a user and automatically by said processor; and
said processor being configured to apply data entered into said form locations of said form to staging guidelines embodied in a logic algorithm accessible by the processor, said processor being configured to execute said logic algorithm to calculate a suggested stage for the patient, and to display the calculated suggested stage at said display monitor.

2. A system as claimed in claim 1 wherein said processor is configured to apply data to said staging guidelines selected from the group consisting of data derived from the patient medical image data, data entered manually, and data retrieved from a patient record.

3. A system as claimed in claim 1 wherein said data entry fields of said form correspond to a selected region of interest in the displayed patient medical image data.

4. A system as claimed in claim 3 comprising selecting said region of interest by executing a segmenting operation manually or automatically via said processor.

5. A system as claimed in claim 3 comprising selecting said region of interest by a user action via said processor.

6. A system as claimed in claim 2 wherein said processor is configured to apply data to said staging guidelines selected from the group consisting of data derived from the patient medical image data and data retrieved from a patient record, and wherein said processor is configured to allow said data applied to said staging guidelines to be manually overwritten by a user.

7. A system as claimed in claim 1 wherein said patient medical image data contain a representation of a lesion, and wherein said processor is configured to allow a manual entry into one of said data fields that designates said lesion as stage-critical, and wherein said processor is configured to evaluate alternative classifications to derive a plurality of suggested patient stages respectively for the alternative classifications.

8. A system as claimed in claim 1 comprising an interface to a clinical reporting system, and wherein said processor is configured to communicate said data and the calculated suggested stages to said clinical reporting system for inclusion in a clinical report generated by the clinical reporting system.

9. A system as claimed in claim 1 wherein said processor is configured to display said form with check boxes and data entry fields as said data entry locations.

10. A system for displaying medical image data, comprising:
a processor having access to medical image data of a patient, said medical image data comprising representations of identified potential lesions;
a display monitor in communication with said processor; and
said processor being configured to execute a patient stage algorithm to cause said medical image data to be displayed at said display monitor with the identified potential lesions being provided with a visual designation corresponding to the respective influence of each identified potential lesion on patient stage.

11. A system as claimed in claim 10 wherein said processor is configured to identify a respective potential lesion as being stage-critical when a classification of the respective potential lesion as benign or malignant has an effect the calculated patient stage.

12. A system as claimed in claim 11 comprising representing each stage-critical lesion with a designation indicating membership of the respective stage-critical lesion in a group designating the respective lesion dependent on classification thereof as being benign or malignant.

13. A system as claimed in claim 11 wherein said processor is configured to display each stage-critical lesion with a designation indicating inclusion of the respective stage-critical lesion in a group representing two respective patient stages, dependent on classification of the respective stage-critical lesion as benign or malignant.

14. A system as claimed in claim 13 wherein processor is configured to allow a user to designate membership of respective stage-critical lesion in said group.

15. A system as claimed in claim 10 wherein said processor is configured to allow a user to assign a potential lesion with a classification as benign or malignant, and wherein the processor is configured to calculate a status of other potential lesions in said medical image data dependent on said assigned classification.

16. A system as claimed in claim 15 wherein said processor is configured to display the status of said other potential lesions at said display monitor.

17. A non-transitory, computer-readable data storage medium encoded with programming instructions, said storage medium being loaded into a processor that is in communication with a display monitor, and said programming information causing said processor to:
access to a data base containing patient medical image data and display said patient medical image data at said display monitor together with a form having entry locations therein allowing entry of data into said form locations by a user and automatically by said processor; and
said processor being configured to apply data entered into said form locations of said form to staging guidelines embodied in a logic algorithm accessible by the processor, said processor being configured to execute said logic algorithm to calculate a suggested stage for the patient, and to display the calculated suggested stage at said display monitor.

18. A non-transitory, computer-readable data storage medium encoded with programming instructions, said storage medium being loaded into a processor that is in communication with a display monitor, and said programming information causing said processor to:
access to medical image data of a patient, said medical image data comprising representations of identified potential lesions; and
execute a patient stage algorithm to cause said medical image data to be displayed at said display monitor with the identified potential lesions being provided with a visual designation corresponding to the respective influence of each identified potential lesion on patient stage.
